(19) United States
(12) Patent Application Publication
(10) Pub. No.: US 2002/0075478 A1
(43) Pub. Date: Jun. 20, 2002

(54) Inspection device having wafer exchange stage

(75) Inventors: Jaim Nulman, Palo Alto, CA (US); Manoocher Birang, Los Gatos, CA (US)

Correspondence Address: PATENT COUNSEL, APPLIED MATERIALS, INC., Legal Affairs Department, P.O. BOX 450A, Santa Clara, CA, 95052, US

(73) Assignee: Applied Materials, Inc.

(21) Appl. No.: 09/739,137

(22) Filed: Dec. 18, 2000

(51) Int. Cl. G01N 21/00

(52) U.S. Cl. 356/237.2

(57) ABSTRACT

The invention provides an inspection device that may inspect (check alignment of or detect defects on) a wafer and that may inspect a wafer while a wafer handler supplies wafers to and/or extracts wafers from the inspection device. The inspection device may include a rotatable wafer platform having a wafer supporting surface, a wafer stage and a lift/lower mechanism coupled to the wafer. The wafer stage has an upper wafer support and a lower wafer support.

### BACKGROUND OF THE INVENTION

Conventional wafer inspection devices may comprise a platform having a rotatable surface and a sensor positioned above the platform. When the inspection device is configured to align a wafer, the wafer sensor may identify when the flat/notched region of the semiconductor wafer is in a predetermined position and may transmit this information to a controller, which then signals the platform to cease rotation. When the inspection device is configured to detect defects on a wafer, the sensor may identify defects and may transmit defect size, number and/or location information to a controller for later use.

Wafer transfer to, wafer inspection at, and wafer transfer from conventional inspection devices (i.e., the wafer transfer and inspection operation) may follow the same sequence: 1) a wafer handler extracts a first wafer from a multi-slot wafer carrier and transports the first wafer to the inspection device; 2) the inspection device inspects (i.e., checks for defects or aligns) the first wafer; and 3) the wafer handler returns the inspected first wafer to the multi-slot wafer carrier. Thereafter the sequence repeats and the wafer handler extracts a second wafer from the multi-slot wafer carrier and transports the second wafer to the inspection device, etc.

As indicated by the sequence described above, conventional wafer inspection devices may allow only the wafer handler or the inspection device to operate at a given time (i.e., serial operation); the wafer handler remains idle while the inspection device operates, and the inspection device remains idle while the wafer handler operates. Such serial operation wastes equipment operating time, reducing throughput and increasing wafer costs.

Accordingly a need exists for an improved inspection device that may reduce equipment operating time.

### SUMMARY OF THE INVENTION

The invention provides an inspection device that may inspect a wafer and that may operate in parallel with a wafer handler. The inspection device may comprise a rotatable wafer platform having a wafer supporting surface and a wafer stage having an upper wafer support adapted to support a wafer and a lower wafer support adapted to support a wafer. A lift/lower mechanism may be coupled to the wafer stage and adapted to lift and lower the wafer stage such that a wafer may be transferred between the upper wafer support of the wafer stage and the wafer supporting surface and such that a wafer may be transferred between the lower wafer support of the wafer stage and the wafer supporting surface; and a sensor coupled so as to sense a wafer positioned on the wafer supporting surface, yet not so as to obstruct wafer transfer between the wafer stage and the wafer supporting surface.

The invention further provides a method of aligning a wafer which may comprise placing a first wafer on a wafer stage of an inspection device; lowering the first wafer onto a wafer platform aligning the first wafer on the platform; placing a second wafer on the wafer stage; elevating the wafer stage so as to transfer the first wafer from the wafer platform to the wafer stage; and extracting the first wafer from the wafer stage, wherein placing the second wafer on the wafer stage may occur before, after or as the first wafer is transferred from the wafer platform to the wafer stage.

Other features and aspects of the present invention will become more fully apparent from the following detailed description of the preferred embodiments, the appended claims and the accompanying drawings.

### BRIEF DESCRIPTION OF THE DRAWINGS

FIGS. 1A-B are a side view and a top view, respectively, of an inventive inspection device;

FIG. 2 is a perspective view of a wafer stage of the inventive inspection device of FIG. 1;

FIG. 3A is a perspective view of the defect sensor of the inventive inspection device;

FIG. 3B is an exploded view of the wafer supporting pads of FIG. 3A;

FIG. 4 is a timing diagram useful in comparing the wafer transport and processing operation of the inventive inspection device and the wafer transport and processing operation of a conventional wafer inspection device; and

FIG. 5A is a side view of a second aspect of the inventive inspection device; and

FIG. 5B is a perspective view of a wafer stage and the wafer supporting platform of a second aspect of the inventive inspection device.

### DETAILED DESCRIPTION OF THE PREFERRED EMBODIMENTS

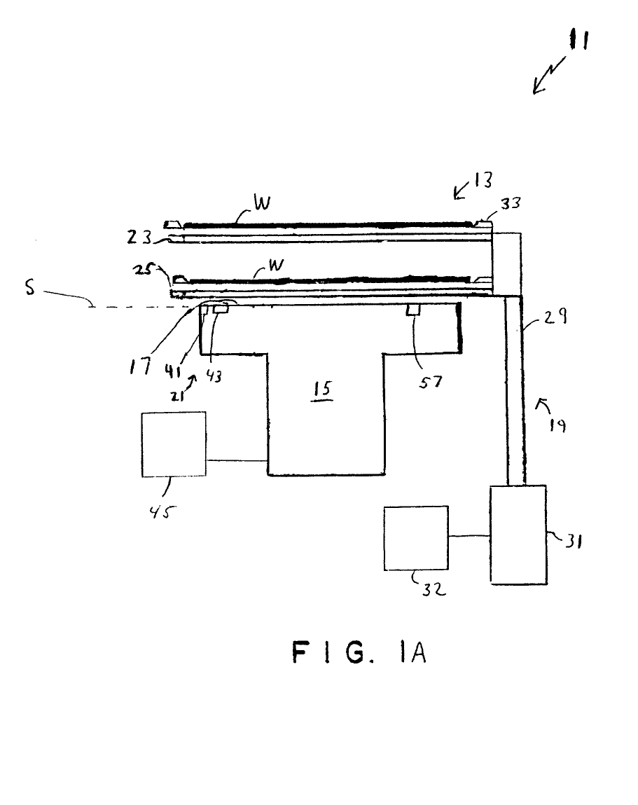

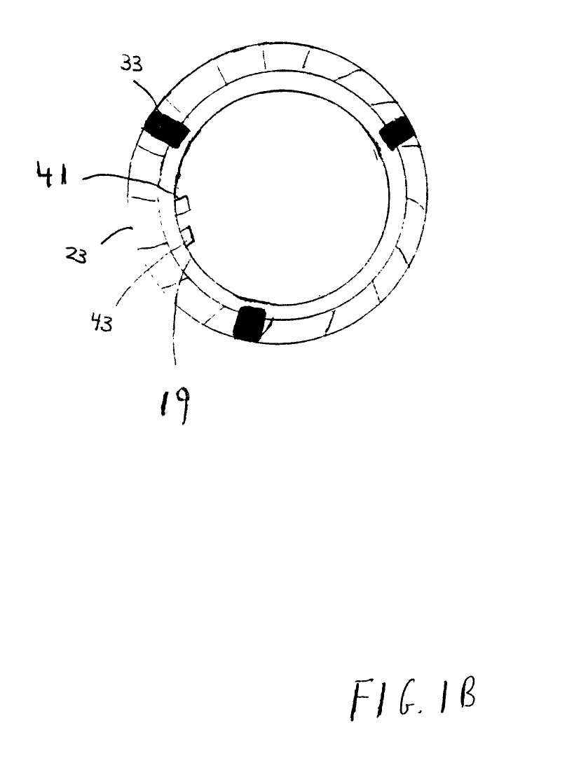

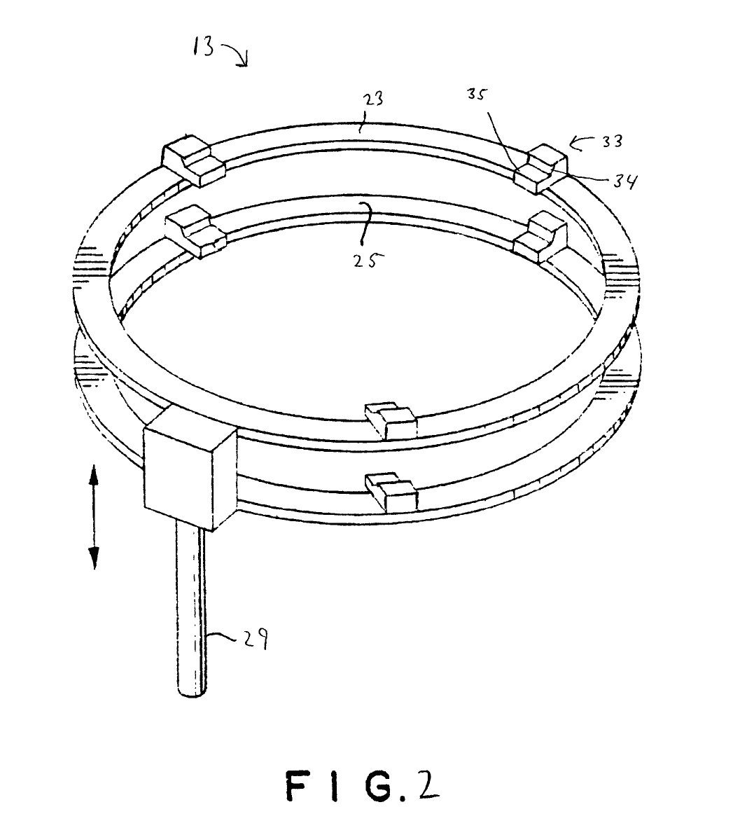

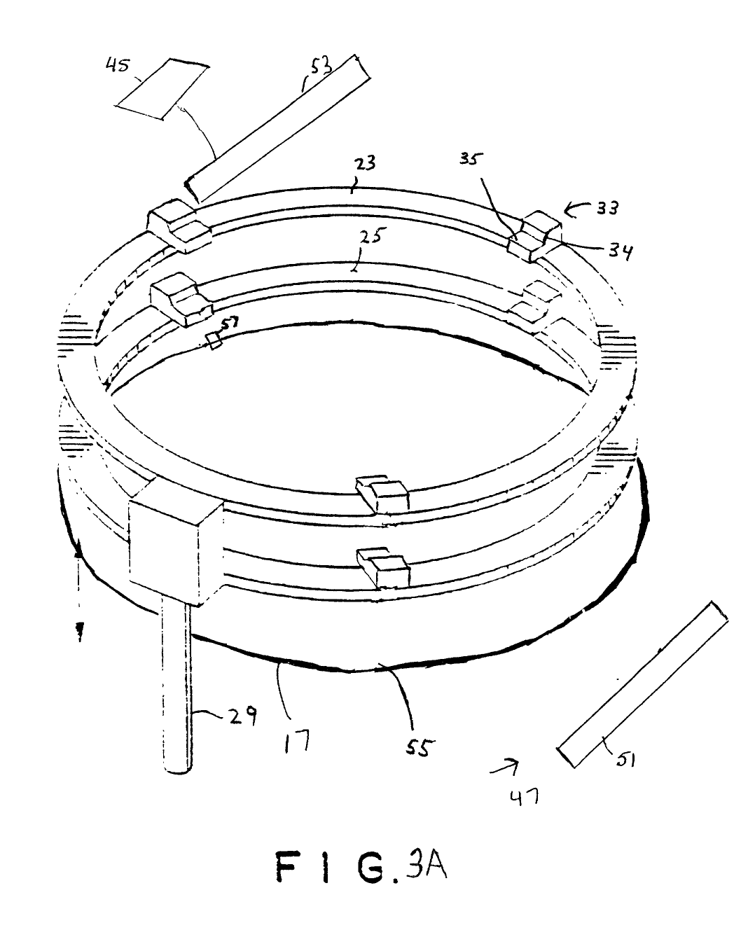

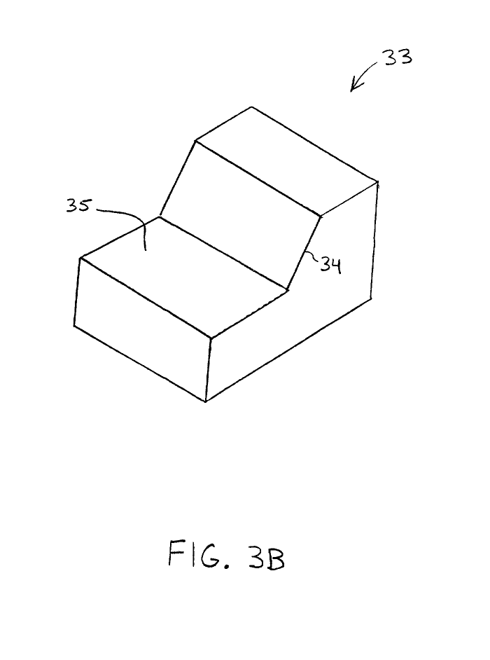

An inventive inspection device is provided that may inspect a wafer and that may simultaneously operate with a wafer handler (i.e., parallel operation). The inventive inspection device is described below with joint reference to FIGS. 1A-B and FIGS. 2-3B. FIGS. 1A-B are a side view and a top view, respectively, of an inventive inspection device 11. FIG. 2 is a perspective view of a wafer stage 13 of the inventive inspection device 11, and FIG. 3A is a perspective view of a defect sensor of the inventive inspection device 11. The inventive inspection device 11 comprises a wafer platform 15 that may rotate a wafer W positioned thereon and that has a wafer supporting surface 17, a wafer stage 13 coupled to the wafer platform 15, a lift/lower mechanism 19 coupled to the wafer stage 13 and adapted to lift and lower the wafer stage 13, and a wafer sensor 21 coupled so as to sense a wafer W positioned on the wafer supporting surface 17, yet not so as to obstruct wafer transfer between the wafer stage 13 and the wafer supporting surface 17. The wafer supporting surface 17 is adapted to hold a wafer W in a flat, horizontal position, and may or may not employ a vacuum chuck, an electrostatic chuck or other known methods adapted to hold the wafer W in a flat, horizontal position. In one aspect, the diameter of the wafer supporting surface 17 is smaller than the diameter of a wafer W positioned thereon.

The wafer stage 13 may comprise an upper wafer support 23, and a lower wafer support 25 coupled below the upper wafer support 23. The lift/lower mechanism 19 is adapted to lift and lower the wafer stage 13 such that a wafer may be transferred between the upper wafer support 23 of the wafer stage 13 and the wafer supporting surface 17, and such that a wafer may be transferred between the lower wafer support 25 of the wafer stage 13 and the wafer supporting surface 17. Specifically, the lift/lower mechanism 19 is adapted to lift and lower the wafer stage 13 between various positions, such as (1) a first position in which the upper wafer support 23 is below the wafer supporting surface 17 (for clarity the wafer supporting surface elevation is represented on FIG. 1A by datum line S) of the wafer platform 15 (and the lower wafer support 25 is further below the wafer supporting surface 17 of the wafer platform 15); (2) a second position in which the upper wafer support 23 and the lower wafer support 25 are both above the wafer supporting surface 17 (above datum line S); and (3) a third position in which the upper wafer support 23 is above the wafer supporting surface 17 (above datum line S) while the lower wafer support 25 is below the wafer supporting surface 17 (below datum line S).

The lift/lower mechanism 19 may comprise a shaft 29 coupled to the upper wafer support 23 and the lower wafer support 25, and an elevator driver 31 (FIG. 1A) adapted to lift and lower the wafer stage 13 between various positions. An exemplary elevator driver may comprise a stepper, or other motor capable of fine rotational positioning adjustment and shaft 29 may be a lead screw coupled to the output of the motor and received through a threaded member such as a nut rigidly attached to stage 13 (stage 13 being fixed against rotation). Thus, rotation of shaft 29 results in linear motion of stage 13 to position the upper and lower wafer supports 23, 25 relative to the wafer supporting surface 17. A controller 32 is coupled to the elevator driver 31 and is adapted to control the operation of the wafer stage 13.

The upper wafer support 23 and the lower wafer support 25 may each comprise a hoop. The inner diameters of both the upper wafer support 23 and the lower wafer support 25 are larger than the diameter of the wafer supporting surface 17 and may be concentric therewith.

Both the upper wafer support 23 and the lower wafer support 25 may comprise a plurality of pads 33 (best shown in FIG. 2), which extend both upwardly and inwardly from the hoop portion of the wafer supports 23 and 25 and are adapted to support a wafer W in a horizontal orientation. In one aspect, the upper wafer support 23 and the lower wafer support 25 each have three equally spaced pads 33. In one aspect, the distance between two adjacent pads 33 on both the upper wafer support 23 and the lower wafer support 25 is larger than the width of a wafer handler's blade, such that a blade of a wafer handler (not shown) may pass there between. It will be understood that the pads 33 may extend a sufficient distance above the hoop portion of the wafer support 23, 25, so as to allow a wafer handler's blade to travel between the pads 33 and the hoop portion of the support, i.e., between the space occupyable by a wafer and the underlying hoop structure.

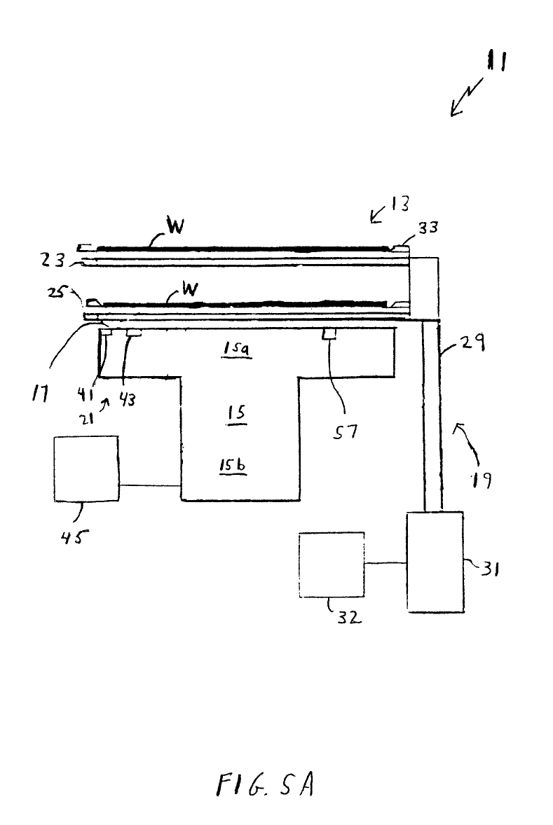

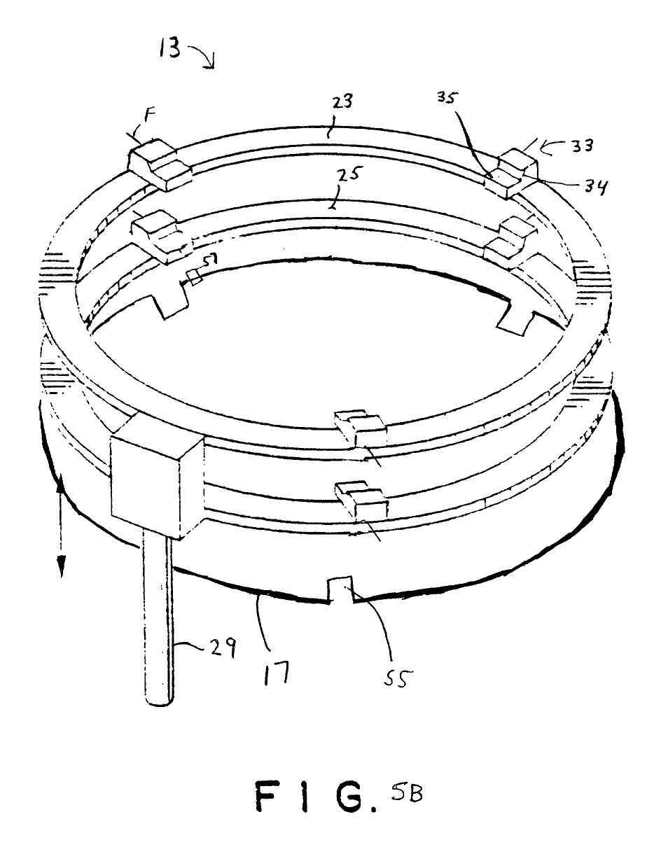

In one aspect, as shown in the exploded view of FIG. 3B, the pads 33 may have an upper portion that comprises an inwardly angled surface 34 and a bottom portion that comprises an inwardly extending surface 35 (extending toward the center of each wafer support 23, 25 because the desired position of the wafer's edge is closed to the hoop portion of the particular support 23 or 25). The pads 33 may be adapted so as to center a wafer W as a wafer handler (not shown) places the wafer W on either the upper wafer support 23 or the lower wafer support 25 (i.e., are wafer centering pads 33). In operation, the centering pads 33 may guide an off-centered wafer into a centered position between the plurality of centering pads 33 by causing the off center wafer to slide inwardly of the hoop diameter if the wafer contacts the angled surface 34 as if it is being positioned on the pad. The centering pads 33 thus create an area of tolerance or a capture window within which a wafer W may be received. In one aspect, the inwardly extending surface 35 of the pads 33 does not extend into the diameter of the wafer supporting surface 17 as the wafer stage 13 travels between various position, so as to not obstruct wafer transfer between the wafer stage 13 and the wafer supporting surface 17. In this embodiment, the diameter of the wafer supporting surface 17 is less than the wafer's diameter. Alternatively, notches may be formed in the wafer platform, and appropriate adjustment could be made to the control program, as described with reference to FIGS. 5A and 5B, such that the wafer supporting surface, of inwardly extending surface 35, is at least positioned below the plane defining the wafer support surface 17. For example, a continuous notch having a depth and linear size larger than the pad could be provided about the circumference of the wafer supporting surface 17.

The wafer sensor 21 (FIG. 1A) may comprise a light transmitter 41, such as a light emitting diode (LED) and a receiver 43, such as a photodetector. A microcontroller 45 may be coupled to the wafer platform 15 and adapted to control the operation thereof and further adapted to receive a signal from the receiver 43. In one aspect, the wafer sensor 21 employs the use of “reflective measurements” whereby the light transmitter 41 and the receiver 43 may be mounted below the wafer supporting surface 17.

When the flat/notched region of the wafer W positioned on the wafer supporting surface 17 is in a predetermined position (i.e., indicating proper wafer alignment), the wafer W does not block a beam of light that is transmitted by the transmitter 41 (i.e., the beam of light passes through). When the flat/notched region of the wafer W is not in a predetermined position (i.e., the wafer W is misaligned), the wafer W positioned on the wafer supporting surface 17 may reflect a beam of light transmitted by the transmitter 41 toward the receiver 43.

Additionally or alternatively, as shown in FIG. 3, the inventive inspection device 11 may comprise a defect sensor 47 that may comprise a transmitter 51 (e.g., a laser light source) and a detector 53 (e.g., a photodiode). The detector 53 is coupled to the microcontroller 45, which is adapted to receive a signal from the detector 53. The transmitter 51 and the detector 53 may be coupled to opposing walls of a chamber that contains the inventive inspection device 11, such that the detector 53 may collect light reflected from the surfaces of the wafer W. The detector 53 also may measure the magnitude of the light reflected from the surfaces of the wafer W. To calibrate the defect sensor 47, one or more defect-free wafers is scanned using the defect sensor 45 and the magnitude of the light reflected from the defect-free wafer(s) is stored to create a reference signal. Thereafter as each production wafer is scanned, the magnitude of the light reflected (i.e., the reflected detection signal) from the surfaces of the production wafer is compared to the reference signal. Any difference between the reflected detection signal and the reference signal may indicate the presence of a defect.

In order to inspect a wafer's entire surface area an array of transmitters 51 and a corresponding array of detectors 53 may be employed such that many closely spaced points along the surface of the wafer are illuminated by light as the wafer W rotates.

In operation, for example, the upper wafer support 23 and the lower wafer support 25 initially both may be positioned above the wafer supporting surface 17. In operation, a wafer handler (not shown) carrying a first wafer positions the first wafer above the lower wafer support 25. Upon actuation, the elevator driver 31 lifts the wafer stage 13 such that the pads 33 of the lower wafer support 25 contact the first wafer and lift the first wafer from the wafer handler's blade, which then retracts. Alternatively, the blade may be moved relative to the horizontal datum line S (FIG. 1A) to position the wafer on the upper or lower wafer support 23 or 25. Because the pads 33 may extend above the hoop portion of the wafer support 25, the wafer stage may elevate so that the pads 33 raise above the wafer handler blade, yet the hoop portion of the support 25 does not contact the wafer handler blade. The pads 33 may optionally align the first wafer as the first wafer slides along the inwardly angled surface 34 as previously described. The elevator driver 31 then lowers the wafer stage 13 until the lower wafer support 25 is below the wafer supporting surface 17, such that the first wafer is positioned on the wafer supporting surface 17.

The wafer platform 15 rotates the first wafer, while the wafer sensor 17 senses for the flat or notched region of the first wafer and/or the defect sensor 47 senses for defects. The wafer sensor 17 and/or the defect sensor 47 output wafer alignment and/or defect information to the microcontroller 45. When wafer alignment is to be performed, once the wafer's flat or notched region is sensed, the microcontroller 45 may output a signal to the wafer platform 15 to cease rotation thereof, or to continue rotating to a position whereby the notch or flat is otherwise properly aligned for processing of the wafer, thereby placing the wafer W in a desired orientation.

While the first wafer is being inspected, the wafer handler travels back to a wafer carrier (not shown) and extracts a second wafer therefrom. As or after the first wafer is aligned, the wafer handler positions a second wafer on the upper wafer support 23 using the same technique described above. Thereafter the elevator driver 31 lifts the wafer stage 13 such that the lower wafer support 25 raises to a level above the wafer supporting surface 17, causing the lower wafer support 25 to lift the first wafer off of the wafer supporting surface 17. Thus, to ensure that the wafer on surface 17 is not disturbed during placement (or removal) of a wafer on upper wafer support 25, the pads 33 on lower wafer support 23 must not extend above horizontal datum line S (FIG. 1A) during this operation. The wafer handler (which has deposited the second wafer on the upper wafer support 23) then extracts the first wafer from the lower wafer support 25. Note, the second wafer may be deposited on the wafer stage 13 before, after or as the wafer stage 13 elevates and lifts the first wafer off of the wafer supporting surface 17.

The wafer stage driver 31 then lowers the wafer stage 13 until the upper wafer support 23 is below the wafer platform 15's wafer supporting surface 17, such that the second wafer is positioned on the wafer supporting surface 17. Thus, both the upper wafer support 23 and the lower wafer support 25 are below the wafer supporting surface 17. The inventive inspection device 11 then inspects the second wafer. While the second wafer is being inspected, the wafer handler travels back to a wafer carrier and extracts a third wafer therefrom. After the second wafer is inspected, the wafer stage driver 31 lifts the wafer stage 13 to position the wafer on the upper wafer support 23, and until the lower wafer support 25 is above the wafer supporting surface 17.

The wafer handler carrying a third wafer positions the third wafer on the lower wafer support 25 and retracts. The wafer stage 13 then lowers to position the third wafer on the support surface 17, after or during which the second wafer is removed from the upper support 25 and replaced with yet another wafer. The sequence described above repeats until each wafer within a wafer carrier has been processed. Although less preferred, the operating sequence described above may be reversed so that the wafer handler initially deposits the first wafer on the upper wafer support 23 rather than on the lower wafer support 25.

As is evident from the description above, the wafer handler and the inventive inspection device 11 may operate in parallel. Such parallel operation allows the wafer handler to proceed to either the upper wafer support 23 or to the lower wafer support 25, to extract a first wafer therefrom directly after depositing a second wafer either on the upper wafer support 23 or on the lower wafer support 25 (i.e., the second wafer placement and the first wafer extraction may occur consecutively). Thereafter inspection of the second wafer may take place directly after inspection of the first wafer, without having to wait while the wafer handler operates (i.e., inspection of the first and second wafer occurs consecutively).

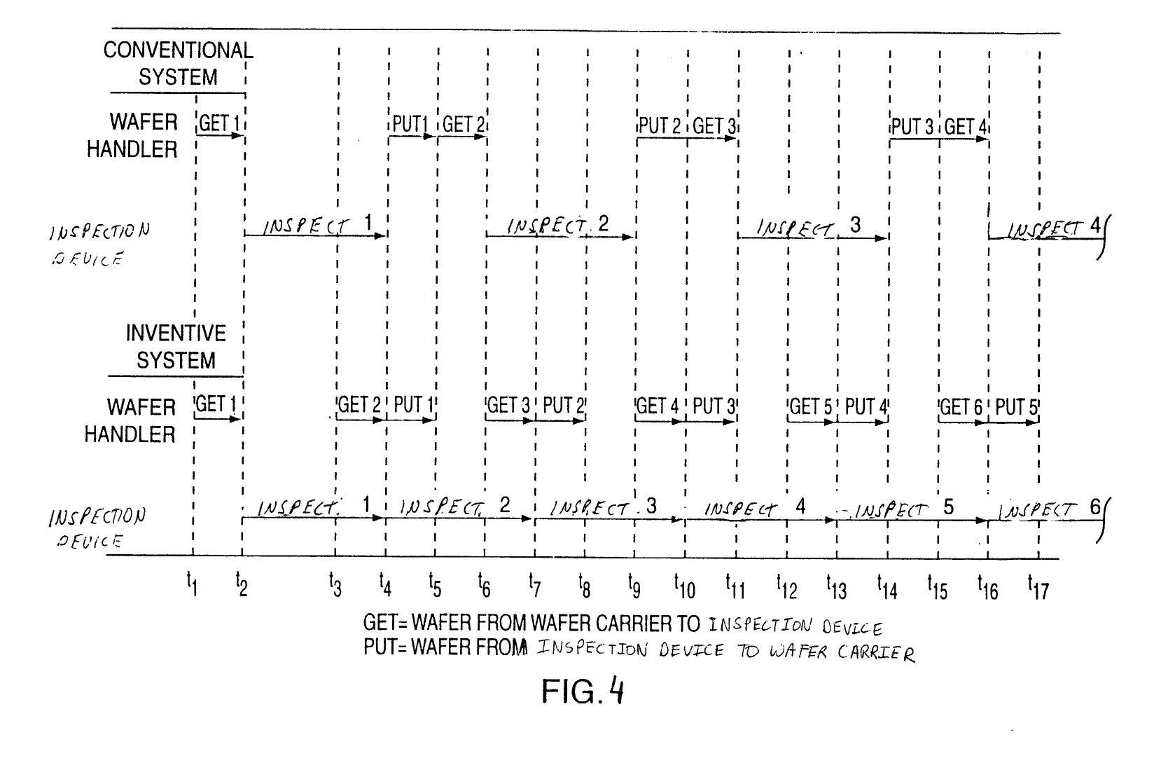

FIG. 4 is an exemplary timing diagram useful in comparing the wafer transport and processing operation of the inventive inspection device 11 and the wafer transport and processing operation of a conventional wafer inspection device. The conventional wafer transport and processing operation is represented in the upper portion of FIG. 4. The wafer transport and processing operation of the inventive inspection device 11 is represented in the lower portion of FIG. 4. To facilitate explanation the operating steps are abbreviated within FIG. 4 as follows:

Get N=extract wafer number N from the wafer carrier and transport wafer number N to the inspection device;

Put N=extract wafer number N from the inspection device and transport wafer number N to the wafer carrier;

Inspect N=inspect wafer number N.

At time t₁:

within the conventional system the wafer handler gets a first wafer from the wafer carrier and places it on the inspection device;

within the inventive system the wafer handler gets a first wafer from the wafer carrier and places it on the lower wafer support 25 of the inspection device.

At time t₂:

within the conventional system the inspection device inspects the first wafer while the wafer handler idles;

within the inventive system the wafer stage driver 31 lowers the lower wafer support 25 below the wafer supporting surface 17 of the wafer platform 15 such that the first wafer is positioned on the wafer supporting surface 17. The inspection device inspects the first wafer while the wafer handler travels to the wafer carrier. Note that the time to lift and lower each wafer is negligible compared to the inspection time, and is therefore not shown in FIG. 3.

At time t₃:

within the conventional system the wafer handler continues to idle while the inspection device inspects the first wafer;

within the inventive system the wafer handler extracts a second wafer from the wafer carrier and places the second wafer on the upper wafer support 23 of the inspection device while the inspection device continues to inspect the first wafer. After the first wafer is inspected, the wafer stage driver 31 lifts the wafer stage 13 such that the first wafer is lifted off of the wafer platform 15.

At time t₄:

within the conventional system the wafer handler transfers the first wafer from the inspection device to the wafer carrier while the inspection device idles;

within the inventive system the wafer handler transfers the first wafer from the lower wafer support 25 of the inspection device to the wafer carrier while the wafer stage driver 31 lowers the upper wafer support 23 below the wafer supporting surface 17 of the wafer platform 15, so that the second wafer is transferred to the wafer supporting surface 17. The inspection device thereafter inspects the second wafer.

At time t₅:

within the conventional system the wafer handler extracts a second wafer from the wafer carrier, while the inspection device idles;

within the inventive system the inspection device continues to inspect the second wafer.

At time t₆:

within the conventional system the wafer handler idles while the inspection device inspects the second wafer;

within the inventive system the wafer handler gets a third wafer from the wafer carrier and transports the third wafer to the inspection device while the inspection device continues to inspect the second wafer. After the second wafer is inspected, the elevator driver 31 lifts the wafer stage 13 until the lower wafer support 25 is above the wafer supporting surface 17, such that the second wafer is lifted off of the wafer platform 15 by the upper wafer support 23. Then, the wafer handler places the third wafer on the lower wafer support 25 and extracts the second wafer from the upper wafer support 23. Thereafter, the elevator driver 31 lowers the lower wafer support 25 below the wafer supporting surface 17 such that the third wafer is positioned on the wafer supporting surface 17.

At time t₇:

within the conventional system the wafer handler idles while the inspection device continues to inspect the second wafer;

within the inventive system the wafer handler transfers the second wafer from the wafer stage 13 to the wafer carrier while the inspection device inspects the third wafer.

At time t₈:

within the conventional system the wafer handler continues to idle while the inspection device inspects the second wafer;

within the inventive system the inspection device continues to inspect the third wafer.

At time t₉:

within the conventional system the wafer handler transfers the second wafer from the inspection device to the wafer carrier;

within the inventive system the wafer handler gets a fourth wafer from the wafer carrier and transports the fourth wafer to the upper wafer support 23 while the inspection device continues to inspect the third wafer. The elevator driver 31 then lifts the wafer stage 13 such that the third wafer is lifted off of the wafer platform 15. Thereafter, as shown in FIG. 3, the sequence continues in the same manner.

As FIG. 4 clearly depicts, the inventive inspection device 11 may experience significantly less idle time than a conventional wafer inspection device, thereby increasing wafer throughput therethrough. In fact, the inventive inspection device 11 may receive the fourth wafer while a conventional wafer inspection device is still removing the second wafer from the conventional inspection device (as shown at time t₉). Thus, the inventive inspection device 11 may achieve nearly twice the throughput of conventional wafer inspection devices, and may therefore provide a significant advantage over conventional wafer inspection devices.

FIG. 5A is a side view of a second aspect of the inventive inspection device, and FIG. 5B is a perspective view of a wafer stage and the wafer supporting device of a second aspect of the inventive inspection device. In the second aspect, the diameter of the wafer supporting surface 17 is equal to or slightly larger than the diameter of a wafer W positioned thereon. Further, the wafer supporting surface 17 may comprise a plurality of cavities 55 positioned at the edges thereof. The cavities 55 are adapted to allow the pads 33 to travel therethrough as further described below. Although shown as U-shaped, the cavities 55 may comprise other shapes. In one aspect, the wafer supporting surface 17 may comprise three cavities 55 as shown. The pads 33 are aligned with the cavities 21 in the wafer supporting surface 17 such that when the wafer platform 15 is in a predetermined position, the pads 33 may pass through the cavities 55 of the wafer platform 15 as the wafer stage 13 lowers past the wafer supporting surface 17 thereof. In operation, the elevator driver 31 lowers the wafer stage 13 until the lower wafer support 25 and/or the upper wafer support 23 are below a top portion 15a of the wafer platform 15 and have entered a lower, narrow portion 15b of the wafer platform 15 such as a groove in the sidewall of the platform 15, thus allowing the wafer stage 13 to rotate unobstructed by the pads 33. When employed for wafer alignment, after the wafer W is aligned, the wafer sensor 21 detects the position (i.e., aligned position) of the wafer W. The wafer platform 15 may rotate so as to align the wafer supports 23, 25 with the cavities 55 of the wafer supporting surface 17. The microcontroller may record the amount and direction of rotation required. The elevator driver 31 lifts the wafer supports 23, 25 and the wafer sensor 21 then may transmit a signal to a downstream piece of equipment which may adjust its operation based on the orientation information received from the sensor 21 (e.g., the wafer handler may adjust the angle at which it picks up or drops off the wafer, or the signal may be transmitted to the microcontroller 24, which, by employing the recorded rotation and direction may rotate the wafer platform 15 to position the wafer W in the aligned position, etc.).

The wafer supporting surface 17 may also comprise an alignment sensor 57 adapted to transmit a signal when the wafer supporting surface 17 is in a predetermined position, wherein the cavities 21 are aligned so as to allow a portion of the wafer stage 13 to travel therethrough. The alignment sensor 57 may be mounted to the wafer platform 15 and may extend to the side thereof so as to detect an outwardly extending flag f (shown in phantom on FIG. 5B) that may extend outwardly from each of the pads 33.

In an alternative embodiment, the wafer sensor 17 may be rotatably or retractably mounted so as to perform wafer sensing when in a first position and to allow the upper wafer support 23 and the lower wafer support 25 to lift and lower therepast when in a second position. In this embodiment, the wafer sensor 17 may employ a “through-beam” detector for flat or notch sensing. The wafer sensor 17 may have an upper portion having the receiver 43 positioned above the wafer supporting surface 17 and a lower portion having the light transmitter 41 positioned below the wafer supporting surface 17. When the flat/notched region of the wafer W is in a predetermined position (i.e., indicating proper wafer alignment), a beam of light may pass through the flat or notched region to reach the receiver 43. When the flat/notched region of the wafer W is not in a predetermined position (i.e., when the wafer W is misaligned), the wafer W positioned on the wafer supporting surface 17 may block a beam of light transmitted by the transmitter 41.

The foregoing description discloses only exemplary embodiments of the invention, modifications of the above-disclosed apparatus and method which fall within the scope of the invention will be readily apparent to those of ordinary skill in the art. For instance, the number of wafer supports and alignment pads may vary. Additionally, the inventive inspection device 11 may be employed either for a rough preposition or for more sensitive positioning operations. The pads 33 may rotate upwardly/downwardly, or may retract outwardly to allow the stage to lower past the wafer supporting surface. Although many acceptable sensors exist for performing defect inspection, exemplary systems that may be employed are disclosed in U.S. Pat. No. 5,982,921 and U.S. Pat. No. 5,699,447, the entire disclosures of which are incorporated herein by this reference.

Accordingly, while the present invention has been disclosed in connection with the preferred embodiments thereof, it should be understood that other embodiments may fall within the spirit and scope of the invention, as defined by the following claims.

The invention claimed is:

1. An inspection device comprising:
a rotatable wafer platform having a wafer supporting surface;
a wafer stage having:
an upper wafer support adapted to support a wafer; and
a lower wafer support adapted to support a wafer;
a lift/lower mechanism coupled to the wafer stage and adapted to lift and lower the wafer stage such that a wafer may be transferred between the upper wafer support of the wafer stage and the wafer supporting surface and such that a wafer may be transferred between the lower wafer support of the wafer stage and the wafer supporting surface; and
a sensor coupled so as to sense a wafer positioned on the wafer supporting surface, yet not so as to obstruct wafer transfer between the wafer stage and the wafer supporting surface.

2. The apparatus of claim 1 further comprising:
a controller containing a program that directs the lift/lower mechanism to lift and lower the wafer stage.

3. The apparatus of claim 1 further comprising:
a defect sensor coupled so as to detect a defect on wafer positioned on the wafer supporting surface.

4. The apparatus of claim 3 wherein the second sensor comprises an array of laser light sources and an array of photodiodes adapted to receive light transmitted by the laser light sources.

5. The apparatus of claim 1 wherein the upper wafer support and the lower wafer support comprise a plurality of pads adapted to support a wafer in a horizontal orientation.

6. The apparatus of claim 5 wherein the wafer supporting surface comprises a plurality of cavities so as to allow the pads of the upper wafer support and the lower wafer support to pass through the cavities as the wafer stage lowers past the wafer supporting surface.

7. The apparatus of claim 1 wherein the lift/lower mechanism is adapted to lift and lower the wafer stage from a first position in which the upper wafer support is below the rotatable wafer platform's wafer supporting surface to a second position in which the upper wafer support is above the rotatable wafer platform's wafer supporting surface and the lower wafer support is above the rotatable wafer platform's wafer supporting surface.

8. The apparatus of claim 7 wherein the lift/lower mechanism is further adapted to lift and lower the wafer stage to a third position in which the upper wafer support is above the wafer supporting surface and the lower wafer support is below the wafer supporting surface.

9. The apparatus of claim 1 further comprising:
a controller containing a program that directs the lift/lower mechanism to lift and lower the wafer stage.

10. An inspection method comprising:
placing a first wafer on a wafer stage of an inspection device;
inspecting the first wafer;
placing a second wafer on the wafer stage; and
extracting the first wafer from the wafer stage.

11. The method of claim 10 further comprising, prior to inspecting the first wafer, lowering the wafer stage to a level below a wafer supporting surface of a wafer platform until the first wafer is positioned on the wafer supporting surface of the wafer platform.

12. The method of claim 11 further comprising elevating the wafer stage so as to transfer the first wafer from the wafer supporting surface of the wafer platform to the wafer stage.

13. The method of claim 12 wherein placing the second wafer on the wafer stage occurs before the first wafer is transferred from the wafer platform to the wafer stage.

14. The method of claim 12 wherein placing the second wafer on the wafer stage occurs after the first wafer is transferred from the wafer platform to the wafer stage.

15. The method of claim 12 wherein placing the second wafer and extracting the first wafer occur consecutively.

16. The method of claim 15 further comprising inspecting the second wafer.

17. The method of claim 16 wherein inspecting the first wafer and the inspecting the second wafer occur consecutively.

18. The method of claim 17 wherein placing a first wafer on a wafer stage comprises placing a first wafer on a lower wafer support of the wafer stage.

19. The method of claim 18 wherein inspecting the first wafer comprises rotating the first wafer positioned on the wafer supporting surface.

20. The method of claim 19 wherein placing a second wafer on the wafer stage and extracting the first wafer from the wafer stage comprises:
placing a second wafer on the upper wafer support of the wafer stage;
elevating the wafer stage to a level above the wafer supporting surface, thereby causing the lower wafer support to lift the first wafer from the wafer supporting surface; and
extracting the first wafer from the lower wafer support.

21. The apparatus of claim 1 wherein the sensor comprises a defect sensor.

22. The apparatus of claim 21 wherein the sensor comprises an array of light sources and a corresponding array of detectors positioned to detect reflected light from the wafer's surface.

23. The apparatus of claim 1 wherein the sensor comprises an alignment sensor adapted to detect a wafer alignment mark.

24. The apparatus of claim 23 wherein the sensor comprises a reflective sensor.

25. The apparatus of claim 23 wherein the sensor comprises a through beam sensor.
